(19) United States
(12) Patent Application Publication
(10) Pub. No.: US 2026/0044543 A1
(43) Pub. Date: Feb. 12, 2026

(54) COMPUTER SYSTEM AND INFORMATION PROCESSING METHOD

(71) Applicant: Hitachi, Ltd., Tokyo (JP)

(72) Inventors: Naoaki YOKOI, Tokyo (JP); Masashi EGI, Tokyo (JP)

(73) Assignee: Hitachi, Ltd., Tokyo (JP)

(21) Appl. No.: 19/292,101

(22) Filed: Aug. 6, 2025

(30) Foreign Application Priority Data
Aug. 7, 2024 (JP) 2024-130789

(51) Int. Cl. G06F 16/3329; G06F 16/338

(52) U.S. Cl. CPC G06F 16/33295; G06F 16/338

(57) ABSTRACT

When an LLM (Large Language Model) generates an answer to a question, it also presents the external information it referenced. The system includes an answer generation process using the LLM along with a basis extraction process to identify the specific external information sources referenced in generating the answer. The answer generation process creates an answer instruction, prompting the LLM to consider actions needed to obtain the answer. It then generates an answer sentence that includes the result of this reasoning, along with either the answer itself or information about the required actions. Additionally, the system executes these actions, records the execution results, metadata about the referenced external information, and the reasoning outcomes, forming a comprehensive history. The basis extraction process generates basis information to pinpoint relevant reference parts of the external information, based on multiple reference points. This setup enhances transparency and traceability of the information used by the LLM.

### CLAIM OF PRIORITY

The present application claims priority from Japanese patent application JP 2024-130789 filed on Aug. 7, 2024, the content of which is hereby incorporated by reference into this application.

### BACKGROUND OF THE INVENTION

### 1. Field of the Invention

The present invention relates to a business support technology using a large-scale language model (LLM).

### 2. Description of the Related Art

In recent years, LLMs have been used for various purposes. As a technique for processing complex tasks by using LLMs, there is known a technique described in Shunyu Yao, Jeffrey Zhao, Dian Yu2, Nan Du, Izhak Shafran, Karthik Narasimhan, Yuan Cao, “REACT: SYNERGIZING REASONING AND ACTING IN LANGUAGE MODELS,” [online], Oct. 6, 2022, [Retrieved Jul. 16, 2024], Internet <URL: https://arxiv.org/abs/2210.03629> (hereinafter, referred to as Non-Patent Document 1). In Non-Patent Document 1, there is described that steps of thinking, acting, and observing are repeatedly performed and that, in the thinking step, it is determined whether or not an action using a tool is required, for example.

In addition, as a technique for reducing hallucination, retrieval augmented generation (RAG) is known (see Yunfan Gao, Yun Xiong, Xinyu Gao, Kangxiang Jia, Jinliu Pan, Yuxi Bi, Yi Dai, Jiawei Sun, Meng Wang, Haofen Wang, “Retrieval-Augmented Generation for Large Language Models: A Survey,” [online], Dec. 18, 2023, [Retrieved Jul. 16, 2024], Internet <URL: https://arxiv.org/abs/2312.10997>).

### SUMMARY OF THE INVENTION

For example, when an LLM is used for customer support operations, upon receiving an inquiry, the LLM generates an answer by referring to documents such as a manual for a product for which the inquiry has been made. In this case, a user who performs tasks needs to be able to refer to the document referenced by the LLM, as necessary, to determine whether the answer is correct. If the document has a large number of pages or characters, it is considerably time-consuming to search for a sentence on which the answer is based (basis part).

The present invention aims to provide a technique for presenting a basis part for an answer from a document which an LLM has referenced to generate the answer.

A representative example of the invention disclosed in the present application is as follows. That is, there is provided a computer system including a processor, a storage device connected to the processor, and a network interface connected to the processor. The computer system is connected, accessible to a large-scale language model that executes a task according to an instruction sentence describing contents of the task, and a database (DB) that manages external information that is a document the large-scale language model references to execute the task. The processor executes an answer generation process of receiving a question and generating an answer to the question by using the large-scale language model and a basis extraction process of identifying a reference part of the external information that the large-scale language model has referenced to generate the answer. The answer generation process includes a first process of generating an answer instruction sentence and inputting the answer instruction sentence to the large-scale language model, the answer instruction sentence causing the large-scale language model to execute a task of thinking about an action to be taken to obtain the answer, the action including retrieving and collecting the external information, and generating an answer sentence including a result of the thinking and at least either the answer or information regarding the action that needs to be taken according to the thinking, a second process of, when receiving the answer sentence including the information regarding the action, executing the action, generating a history including an execution result of the action, meta-information of the external information retrieved through the action, and the result of the thinking included in the answer sentence, generating the answer instruction sentence including the execution result, and inputting the answer instruction sentence to the large-scale language model, and a third process of, when receiving the answer sentence including the answer, outputting the answer. The basis extraction process includes a fourth process of generating basis information for identifying the reference part of the external information that the large-scale language model has referenced to generate the answer, based on a plurality of the histories.

According to the present invention, a sentence on which the answer is based can be presented from the document which the LLM has referenced to generate the answer. This allows a user to determine whether or not the answer is correct. Problems, configurations, and effects other than those described above will become apparent from the following description of an embodiment.

### BRIEF DESCRIPTION OF THE DRAWINGS

FIG. 1 is a diagram illustrating an example of a configuration of a system according to a first embodiment;

FIG. 2 is a diagram illustrating an example of a hardware configuration of a computer according to the first embodiment;

FIG. 3 is a diagram illustrating an example of a data structure of an external information management DB managed by an external information storage section according to the first embodiment;

FIG. 4 is a diagram illustrating an example of a question sentence in the first embodiment;

FIG. 5 is a diagram illustrating an example of a work instruction sentence in the first embodiment;

FIG. 6 is a diagram illustrating an example of a thinking instruction sentence in the first embodiment;

FIG. 7 is a diagram illustrating an example of a basis extracting instruction sentence in the first embodiment;

FIG. 8 is a diagram illustrating an example of a data structure of a generation history management DB managed by a generation history storage section according to the first embodiment;

FIG. 9 is a diagram illustrating an example of a data structure of an action history management DB managed by an action history storage section according to the first embodiment;

FIG. 10A is a diagram illustrating an example of a data structure of a basis information management DB managed by a basis information storage section according to the first embodiment;

FIG. 10B is a diagram illustrating an example of a data structure of the basis information management DB managed by the basis information storage section according to the first embodiment;

FIG. 11 is a flowchart illustrating an example of an answer generation process executed by an answer generating section according to the first embodiment;

FIG. 12 is a flowchart illustrating an example of an answer instruction sentence generation process executed by the answer generating section according to the first embodiment;

FIG. 13 is a conceptual diagram of the answer instruction sentence generation process executed by the answer generating section according to the first embodiment;

FIG. 14A is a diagram illustrating an example of an answer instruction sentence in the first embodiment;

FIG. 14B is a diagram illustrating an example of the answer instruction sentence in the first embodiment;

FIG. 15 is a flowchart illustrating an example of a process executed by a text generating section according to the first embodiment;

FIG. 16 is a conceptual diagram of the process executed by the text generating section according to the first embodiment;

FIG. 17A is a diagram illustrating an example of an answer sentence in the first embodiment;

FIG. 17B is a diagram illustrating an example of the answer sentence in the first embodiment;

FIG. 18 is a flowchart illustrating an example of an action process executed by an action executing section according to the first embodiment;

FIG. 19 is a conceptual diagram of the action process executed by the action executing section according to the first embodiment;

FIG. 20 is a diagram illustrating an example of a result of an action in the first embodiment;

FIG. 21 is a flowchart illustrating an example of a basis information generation process executed by a basis extracting section of the answer generating section according to the first embodiment;

FIG. 22 is a conceptual diagram of the basis information generation process executed by the basis extracting section of the answer generating section according to the first embodiment;

FIG. 23 is a flowchart illustrating an example of a basis information generation process executed by the basis extracting section of the answer generating section according to the first embodiment;

FIG. 24 is a conceptual diagram of the basis information generation process executed by the basis extracting section of the answer generating section according to the first embodiment;

FIG. 25 is a diagram illustrating an example of the answer instruction sentence in the first embodiment;

FIG. 26 is a diagram illustrating an example of the answer sentence in the first embodiment;

FIG. 27 is a diagram illustrating an example of a screen displayed on a terminal according to the first embodiment;

FIG. 28A is a diagram illustrating an example of the screen displayed on the terminal according to the first embodiment; and

FIG. 28B is a diagram illustrating an example of the screen displayed on the terminal according to the first embodiment.

### DESCRIPTION OF THE PREFERRED EMBODIMENT

Hereinafter, an embodiment of the present invention will be described with reference to the drawings. However, the present invention should not be interpreted as being limited to the description of the embodiment below. It will easily be understood by those skilled in the art that the specific configuration of the invention can be changed without departing from the concept or purpose of the present invention.

In the configuration of the invention described below, the same or similar components or functions are given the same reference signs, and duplicated descriptions are omitted.

In the present specification, such terms as “first,” “second,” and “third” are used to distinguish components from each other and do not necessarily limit the number or order.

In order to facilitate understanding of the invention, the position, size, shape, range, etc., of each component illustrated in the drawings, etc., may not represent the actual position, size, shape, range, etc. Therefore, the present invention is not limited to the position, size, shape, range, etc., disclosed in the drawings, etc.

### First Embodiment

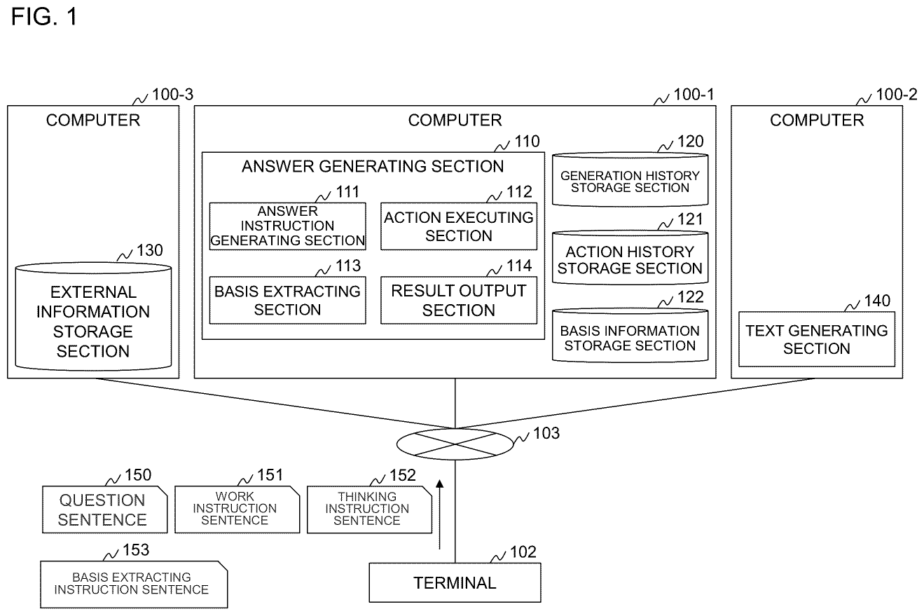

FIG. 1 is a diagram illustrating an example of a configuration of a system according to a first embodiment.

The system of the first embodiment includes a plurality of computers 100-1, 100-2, and 100-3, and a terminal 102. In the following description, when there is no need to distinguish between the computers 100-1, 100-2, and 100-3, they will be referred to as computers 100. The plurality of computers 100 and the terminal 102 are connected to each other via a network 103 such as a local area network (LAN). The connection method may be either wired or wireless.

The terminal 102 is a terminal operated by a user who performs tasks such as customer service operations. The terminal 102 inputs a question sentence 150, a work instruction sentence 151, and a thinking instruction sentence 152 to the computer 100-1 and acquires an answer to the question. Moreover, the terminal 102 inputs a basis extracting instruction sentence 153 to the computer 100-1 to acquire information that is the basis of the answer.

The question sentence 150 is a text including the contents of a question. The work instruction sentence 151 is a text including the contents of work (task) to be executed by an LLM. In the present embodiment, the work of generating an answer to a question is assumed. The thinking instruction sentence 152 is a text including the contents of thinking in the work to be executed by the LLM. The basis extracting instruction sentence 153 is a text including the contents of basis extraction work (task) to be executed by the LLM.

The work instruction sentence 151 and the thinking instruction sentence 152 may be set in advance or may alternatively be set appropriately by the user. Still alternatively, the work instruction sentence 151 and the thinking instruction sentence 152 may be combined together into a template. A template of the basis extracting instruction sentence 153 may be set in advance or may alternatively be set appropriately by the user.

The computer 100-2 has a text generating section 140 that executes a task by using the LLM and generates a text including the execution result. The computer 100-3 has an external information storage section 130 that manages external information that the LLM does not hold as knowledge, such as manuals that the LLM references. The external information is documents. Note that the document may include figures, graphs, and the like in addition to characters.

In the present embodiment, since answer sentences are output from the text generating section 140 a plurality of times, in the following description, an answer to a question will be referred to as a final answer.

The computer 100-1 generates the final answer by using the LLM and the external information. The computer 100-1 includes an answer generating section 110, a generation history storage section 120, an action history storage section 121, and a basis information storage section 122.

The answer generating section 110 generates the final answer in cooperation with the computers 100-2 and 100-3. The answer generating section 110 includes an answer instruction generating section 111, an action executing section 112, a basis extracting section 113, and a result output section 114.

It should be noted that, with regard to each of the functional blocks included in the system, a plurality of functional blocks may be combined into one functional block, or one functional block may be divided into a plurality of functional blocks. For example, the computer 100-1 may have the text generating section 140 or the external information storage section 130. Further, the functional blocks of each computer 100 may be implemented by using a computer system including the plurality of computers 100.

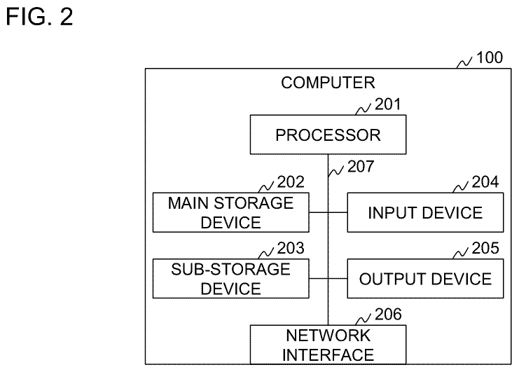

FIG. 2 is a diagram illustrating an example of a hardware configuration of the computer 100 according to the first embodiment.

The computer 100 includes a processor 201, a main storage device 202, a sub-storage device 203, an input device 204, an output device 205, and a network interface 206. The respective hardware elements are connected to one another via a bus 207.

The processor 201 executes a program stored in the main storage device 202. The processor 201 executes processing according to the program, thereby operating as a functional block (module) that fulfills a specific function. In the following description, when processing being executed by a functional block is explained, it means that the processor 201 is executing a program that implements the functional block.

The main storage device 202 is a storage device that stores the programs executed by the processor 201 and information processed by the programs, such as a volatile or non-volatile memory. The main storage device 202 is also used as a work area. The sub-storage device 203 is a large-capacity storage device such as a hard disk drive (HDD) and a solid state drive (SSD).

The input device 204 is a device for receiving external input, such as a keyboard, a mouse, or a touch panel. The output device 205 is a device for outputting various types of information to the outside, such as a display.

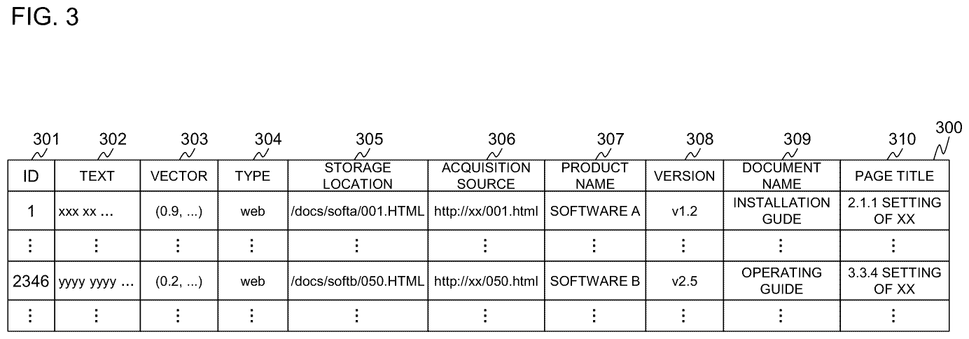

FIG. 3 is a diagram illustrating an example of a data structure of an external information management DB 300 managed by the external information storage section 130 according to the first embodiment.

The external information storage section 130 manages the external information in the external information management DB 300 in a table format as illustrated in FIG. 3, for example. The amount of text (number of characters or number of pages) of external information is huge, while the amount of text that can be accepted by the LLM is limited. Therefore, the external information is divided into partial texts (chunks) of a predetermined size, and the partial texts are managed as vector representations.

The external information management DB 300 stores entries including an identification (ID) 301, a text 302, a vector 303, a type 304, a storage location 305, an acquisition source 306, a product name 307, a version 308, a document name 309, and a page title 310. One entry is made for one partial text.

The ID 301 is a field for storing an ID of a partial text. The text 302 is a field for storing the partial text. The vector 303 is a field for storing a vector representation of the partial text.

The type 304 is a field for storing the type of external information. In the case of external information that exists on the Internet, “Web” is stored in the type 304. The storage location 305 is a field for storing information indicating a storage location of the external information. The acquisition source 306 is a field for storing information indicating an acquisition source of the external information. The product name 307 is a field for storing the name of a product with which the external information is associated. The version 308 is a field for storing a version of the product. The document name 309 is a field for storing the name of the external information. The page title 310 is a field for storing the name of a chapter, a section, or the like that contains the partial text.

Note that the type 304, the storage location 305, the acquisition source 306, the product name 307, the version 308, the document name 309, and the page title 310 are examples of meta-information of external information including partial texts and are not limited to these.

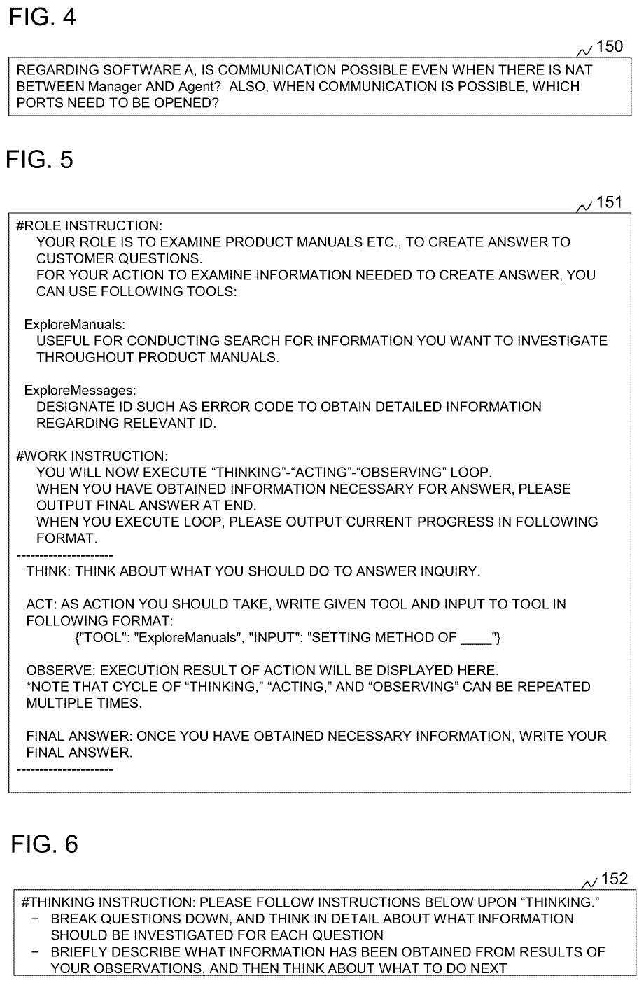

FIG. 4 is a diagram illustrating an example of the question sentence 150 in the first embodiment. FIG. 5 is a diagram illustrating an example of the work instruction sentence 151 in the first embodiment. FIG. 6 is a diagram illustrating an example of the thinking instruction sentence 152 in the first embodiment.

The work instruction sentence 151 describes the contents of a task of repeatedly performing a process including steps of thinking, acting, and observing to generate the final answer.

The thinking instruction sentence 152 describes specific contents of “thinking.” In the “thinking” step, the answer generating section 110 transmits an answer instruction sentence (prompt) to the text generating section 140. Based on the external information and the answer instruction sentence, the text generating section 140 generates an answer sentence including, as a result of the thinking, an action to be taken and the reason for the action, and transmits the answer sentence to the answer generating section 110. Further, the answer sentence includes either an answer or action information regarding the next action to be taken that is obtained through the thinking. The action information includes the name of a tool to be used or a function to call the tool, data to be used, etc.

When the answer sentence contains the action information, the answer generating section 110 proceeds to the “acting” step. In the “acting” step, the answer generating section 110 executes an action by using a tool or the like, based on the result of the thinking. In the present embodiment, retrieval of external information and information collection are executed as the action.

In the “observing” step, the answer generating section 110 acquires the execution result of the action. The answer generating section 110 again generates, in the “thinking” step, an answer instruction sentence including the execution result of the action and the text that has been transmitted and received up to that point, and transmits the generated answer instruction sentence to the text generating section 140.

When the answer sentence contains an answer, the answer generating section 110 ends the task.

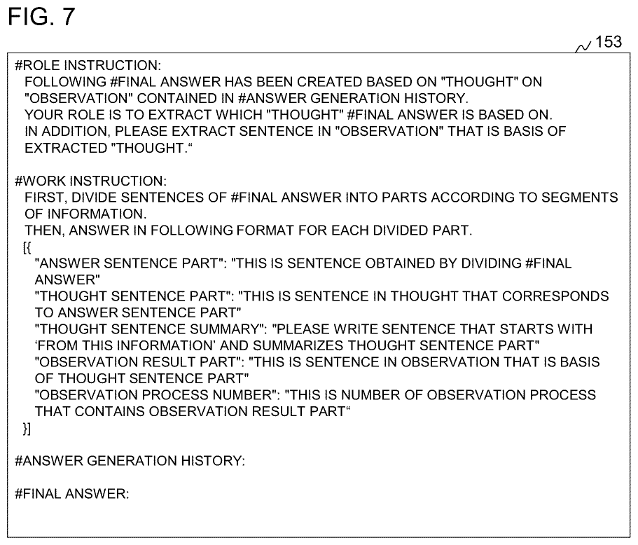

FIG. 7 is a diagram illustrating an example of the basis extracting instruction sentence 153 in the first embodiment.

The basis extracting instruction sentence 153 describes an instruction for a basis extraction work (task) to be executed by the answer generating section 110 and information required for the task.

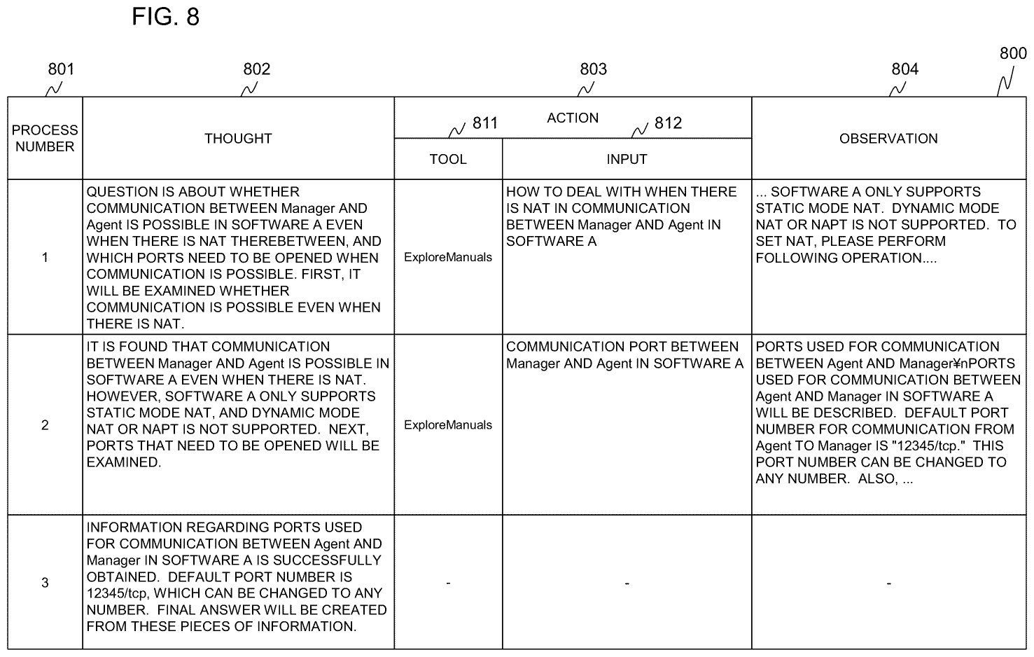

FIG. 8 is a diagram illustrating an example of a data structure of a generation history management DB 800 managed by the generation history storage section 120 according to the first embodiment.

The generation history storage section 120 manages a generation history in the generation history management DB 800 in a table format as illustrated in FIG. 8, for example. The generation history management DB 800 is a database for managing an execution history (generation history) of one process and stores entries including a process number 801, a thought 802, an action 803, and an observation 804. One entry is made for one process.

The process number 801 is a field for storing the number of times the process is executed. The thought 802 is a field for storing text that represents the result of thinking. The action 803 is a field group for storing information regarding an action and includes a tool 811 and input 812. The tool 811 is a field for storing the name of a tool or the like. The input 812 is a field for storing arguments, search words, or the like that are input upon the usage of the tool. The observation 804 is a field for storing the execution result of the action.

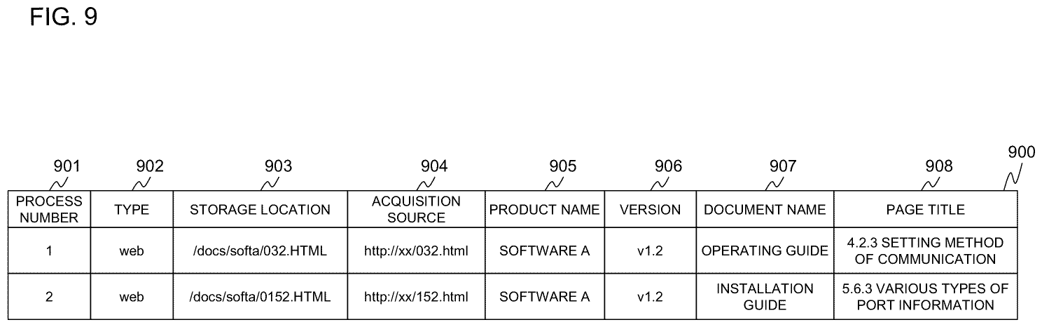

FIG. 9 is a diagram illustrating an example of a data structure of an action history management DB 900 managed by the action history storage section 121 according to the first embodiment.

The action history storage section 121 manages an action history in the action history management DB 900 in a table format as illustrated in FIG. 9, for example. The action history management DB 900 is a database for managing details of external information referenced in an action and stores entries including a process number 901, a type 902, a storage location 903, an acquisition source 904, a product name 905, a version 906, a document name 907, and a page title 908. One entry is made for one process.

The process number 901 is the same field as the process number 801. The type 902, the storage location 903, the acquisition source 904, the product name 905, the version 906, the document name 907, and the page title 908 are the same fields as the type 304, the storage location 305, the acquisition source 306, the product name 307, the version 308, the document name 309, and the page title 310.

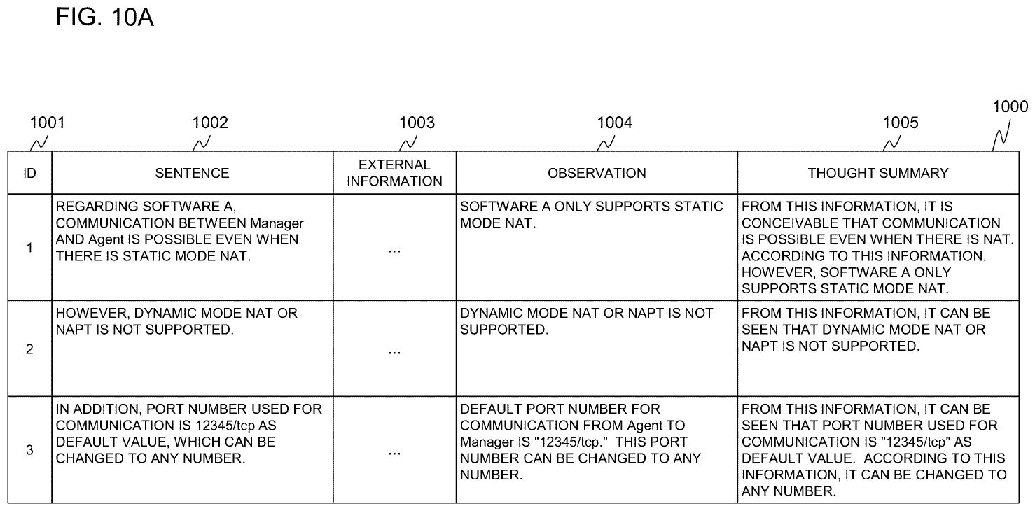

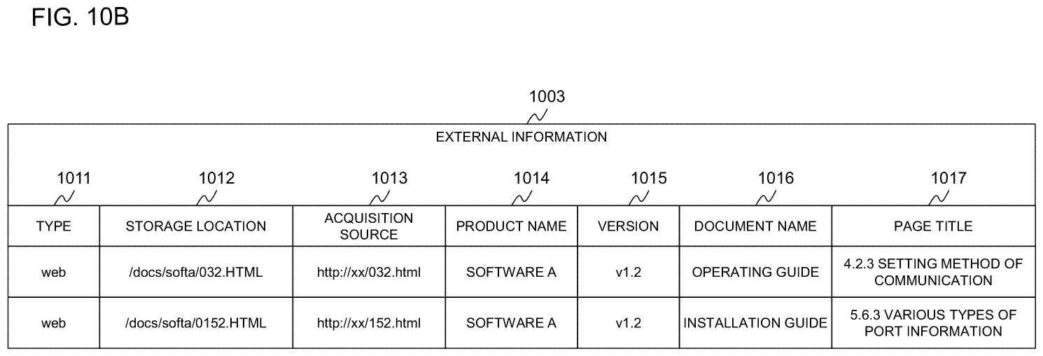

FIG. 10A and FIG. 10B are diagrams illustrating examples of a data structure of a basis information management DB 1000 managed by the basis information storage section 122 according to the first embodiment. Note that the two diagrams will be used for description.

The basis information storage section 122 manages basis information in the basis information management DB 1000 in a table format as illustrated in FIG. 10A and FIG. 10B, for example. The basis information management DB 1000 is a database for managing details of external information that is the basis for the final answer, and stores entries including an ID 1001, a sentence 1002, external information 1003, an observation 1004, and a thought summary 1005. One entry is made for one sentence obtained by dividing the final answer. One entry becomes one piece of basis information.

The ID 1001 is a field for storing an ID of an entry.

The sentence 1002 is a field for storing a sentence (chunk) obtained by dividing an answer (text).

The external information 1003 is a group of fields for storing information related to external information that has been referenced to arrive at a conclusion corresponding to the sentence. The external information 1003 includes a type 1011, a storage location 1012, an acquisition source 1013, a product name 1014, a version 1015, a document name 1016, and a page title 1017. The type 1011, the storage location 1012, the acquisition source 1013, the product name 1014, the version 1015, the document name 1016, and the page title 1017 are the same fields as the type 304, the storage location 305, the acquisition source 306, the product name 307, the version 308, the document name 309, and the page title 310.

The thought summary 1005 is a field for storing a summary of a result of thinking that has led to the conclusion corresponding to the sentence stored in the sentence 1002.

The observation 1004 is a field for storing the execution result of an action taken to obtain the conclusion corresponding to the sentence stored in the sentence 1002.

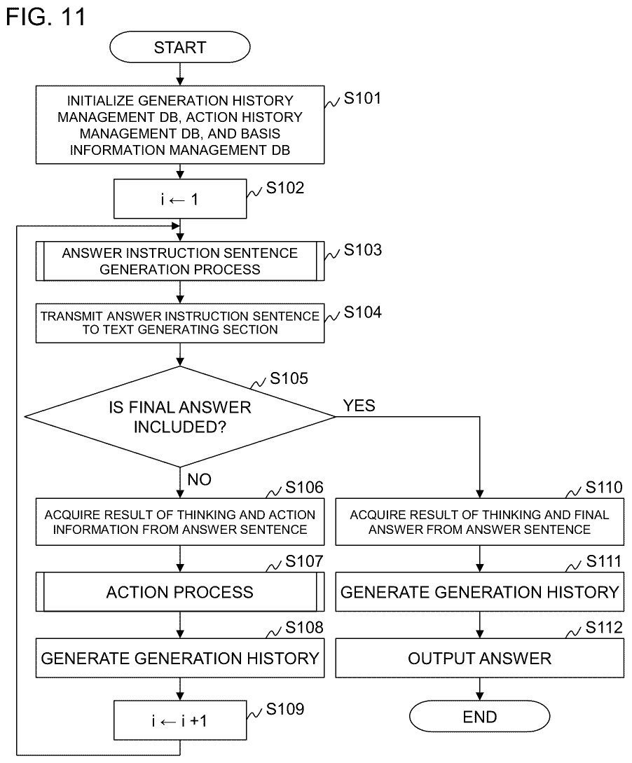

First, a process for obtaining the final answer to a question will be described. FIG. 11 is a flowchart illustrating an example of an answer generation process executed by the answer generating section 110 according to the first embodiment.

When receiving the question sentence 150, the work instruction sentence 151, and the thinking instruction sentence 152 from the terminal 102, the answer generating section 110 starts the process described below.

The answer generating section 110 initializes the generation history management DB 800, the action history management DB 900, and the basis information management DB 1000 (step S101). To be specific, the answer generating section 110 instructs the generation history storage section 120, the action history storage section 121, and the basis information storage section 122 to initialize the databases.

The answer generating section 110 sets a variable i, which indicates a process number, to 1 (step 102)

The answer instruction generating section 111 of the answer generating section 110 executes an answer instruction sentence generation process (step S103). In the answer instruction sentence generation process, an answer instruction sentence (prompt) is generated. The answer instruction sentence generation process will be described in detail later.

The answer generating section 110 transmits the answer instruction sentence to the text generating section 140 (step S104).

When receiving an answer sentence from the text generating section 140, the answer generating section 110 determines whether or not the answer sentence includes the final answer (step S105).

When the answer sentence does not include the final answer, the answer generating section 110 acquires the result of thinking and action information from the answer sentence (step S106).

The action executing section 112 of the answer generating section 110 executes an action process based on the action information (step S107). The action process will be described in detail later.

The answer generating section 110 generates a generation history (step S108), adds 1 to the variable i (step S109), and then returns to step S103.

To be specific, the answer generating section 110 generates an entry, sets the value of the variable i in the process number 801 of the entry, sets the acquired result of thinking in the thought 802, sets the acquired action information in the action 803, and sets the execution result of the action acquired by the action process in the observation 804.

In step S105, when the answer sentence includes the final answer, the answer generating section 110 acquires the result of thinking and the final answer from the answer sentence (step S110), and generates a generation history (step S111).

To be specific, the answer generating section 110 generates an entry, sets the value of the variable i in the process number 801 of the entry, and sets the acquired result of thinking in the thought 802.

The result output section 114 of the answer generating section 110 outputs the final answer included in the answer sentence to the terminal 102 (step S112), and then ends the answer generation process.

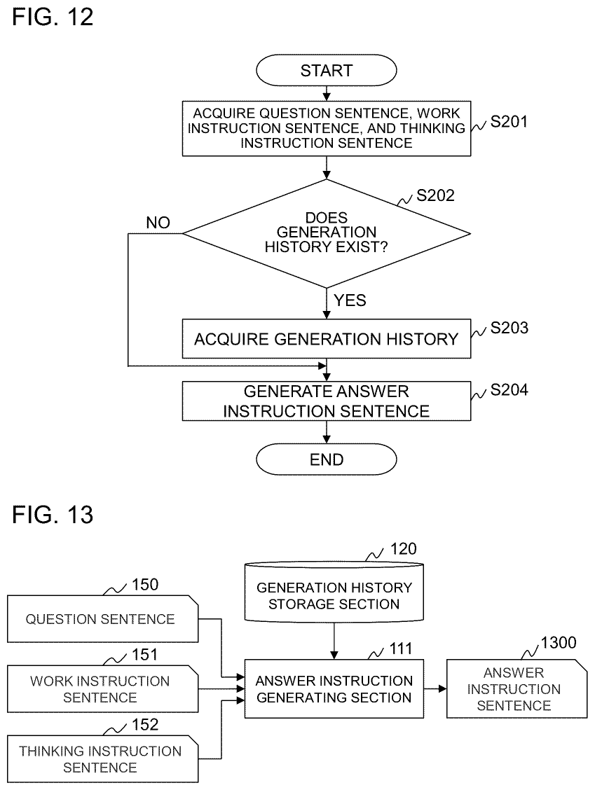

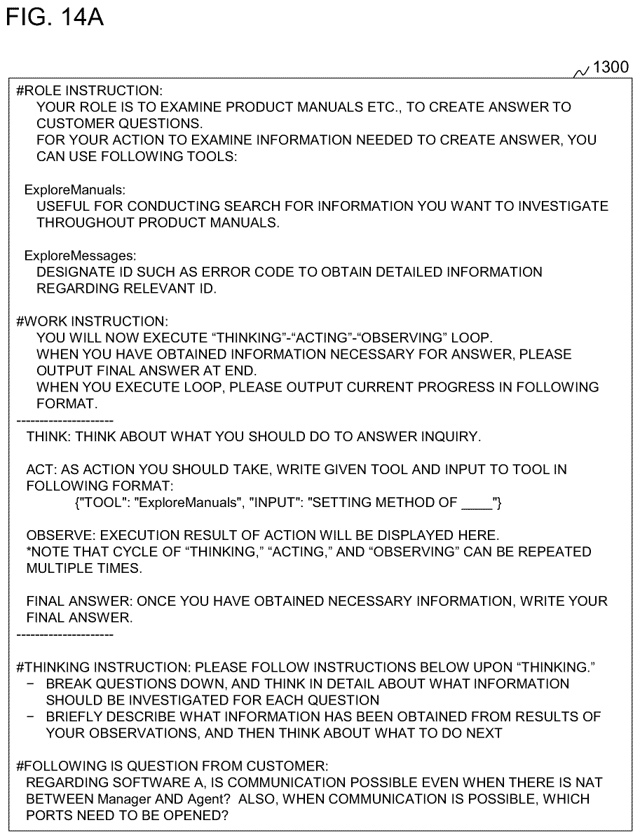

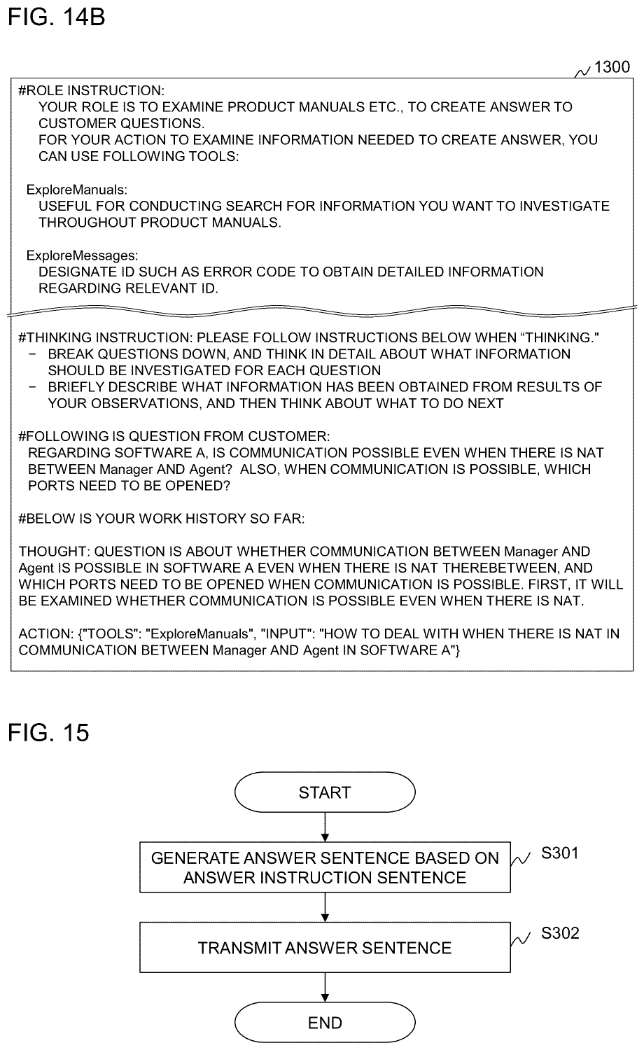

FIG. 12 is a flowchart illustrating an example of the answer instruction sentence generation process executed by the answer generating section 110 of the first embodiment. FIG. 13 is a conceptual diagram of the answer instruction sentence generation process executed by the answer generating section 110 of the first embodiment. FIG. 14A and FIG. 14B are diagrams illustrating examples of the answer instruction sentence in the first embodiment.

The answer instruction generating section 111 acquires the question sentence 150, the work instruction sentence 151, and the thinking instruction sentence 152 (step S201).

The answer instruction generating section 111 refers to the generation history management DB 800 and determines whether or not a generation history exists (step S202).

When there is no generation history, the answer instruction generating section 111 generates an answer instruction sentence 1300 by combining the question sentence 150, the work instruction sentence 151, and the thinking instruction sentence 152 (step S204). After that, the answer instruction generating section 111 ends the answer instruction sentence generation process. In this case, the answer instruction sentence 1300 as illustrated in FIG. 14A is generated.

When the generation history exists, the answer instruction generating section 111 acquires the generation history from the generation history management DB 800 (step S203). The answer instruction generating section 111 combines the question sentence 150, the work instruction sentence 151, and the thinking instruction sentence 152 and then inserts the generation history thereinto to generate the answer instruction sentence 1300 (step S204). After that, the answer instruction generating section 111 ends the answer instruction sentence generation process. In this case, the answer instruction sentence 1300 as illustrated in FIG. 14B is generated. Note that, in FIG. 14B, descriptions related to work instructions are omitted.

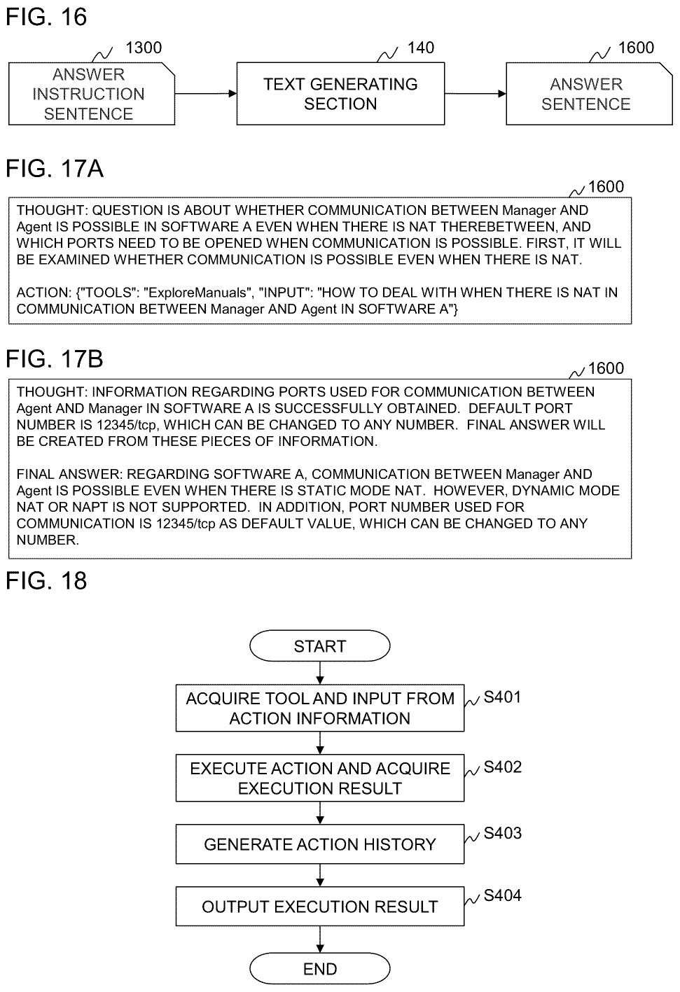

FIG. 15 is a flowchart illustrating an example of a process executed by the text generating section 140 of the first embodiment. FIG. 16 is a conceptual diagram of the process executed by the text generating section 140 of the first embodiment. FIG. 17A and FIG. 17B are diagrams illustrating examples of the answer sentence in the first embodiment.

The text generating section 140 generates an answer sentence 1600 by inputting the answer instruction sentence 1300 into the LLM (step S301).

For example, the answer sentence 1600 as illustrated in FIG. 17A or FIG. 17B is generated. The answer sentence 1600 illustrated in FIG. 17A includes the result of thinking and action information. The action information includes a tool to be used and input such as a search query and arguments. The answer sentence 1600 illustrated in FIG. 17B includes the result of thinking and the final answer.

The text generating section 140 transmits the answer sentence 1600 to the answer generating section 110 (step S302).

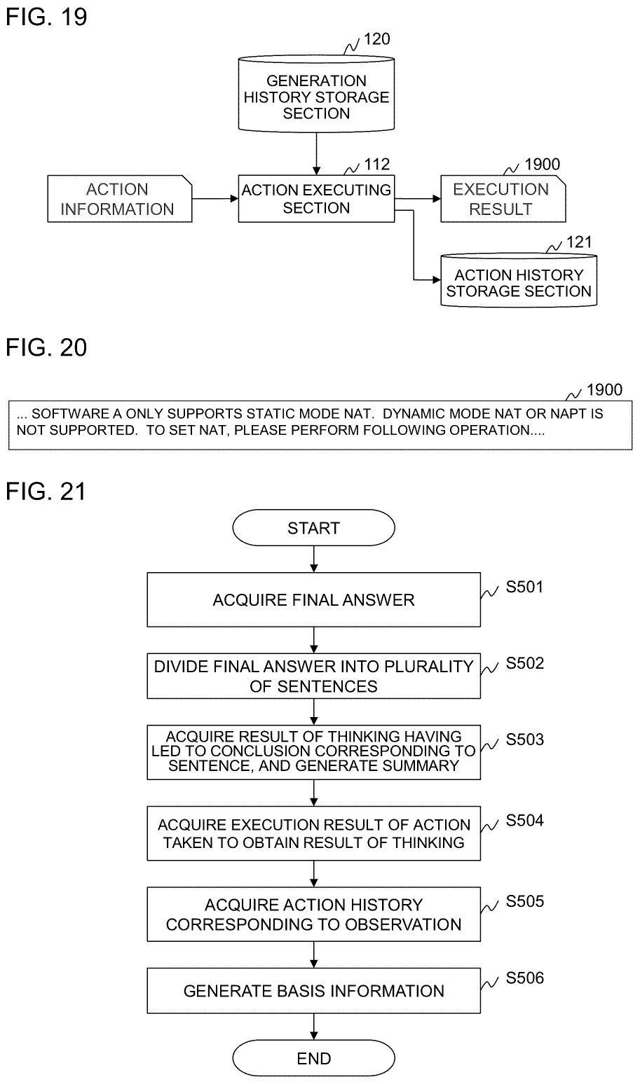

FIG. 18 is a flowchart illustrating an example of the action process executed by the action executing section 112 of the first embodiment. FIG. 19 is a conceptual diagram of the action process executed by the action executing section 112 of the first embodiment. FIG. 20 is a diagram illustrating an example of the result of an action in the first embodiment.

The action executing section 112 acquires the tool and input to be used from the action information (step S401).

The action executing section 112 executes an action by using the tool and the input and acquires an execution result 1900 (step S402). To be specific, the action executing section 112 uses the tool to retrieve external information including information related to the input, and extracts a sentence in which the information related to the input is described, from the external information. As a result, the execution result 1900 as illustrated in FIG. 20 is acquired, for example.

The action executing section 112 generates an action history (step S403). In the present embodiment, since the retrieval of external information and the collection of information are executed as the action, the action executing section 112 sets the value of the variable i in the process number 901 and sets meta-information of the retrieved external information in the type 902, the storage location 903, the acquisition source 904, the product name 905, the version 906, the document name 907, and the page title 908.

The action executing section 112 outputs the execution result 1900 to the answer generating section 110 (step S404), and then ends the action process.

As described above, the answer generating section 110 can track the progress of a task until the final answer is obtained, by recording the task history (generation history and action history) until the final answer is obtained.

Note that, in the present embodiment, the generation history and the action history are managed separately, but they may be managed as one history. For example, a field for recording meta-information of the external information referenced in the action 803 of the generation history may be provided.

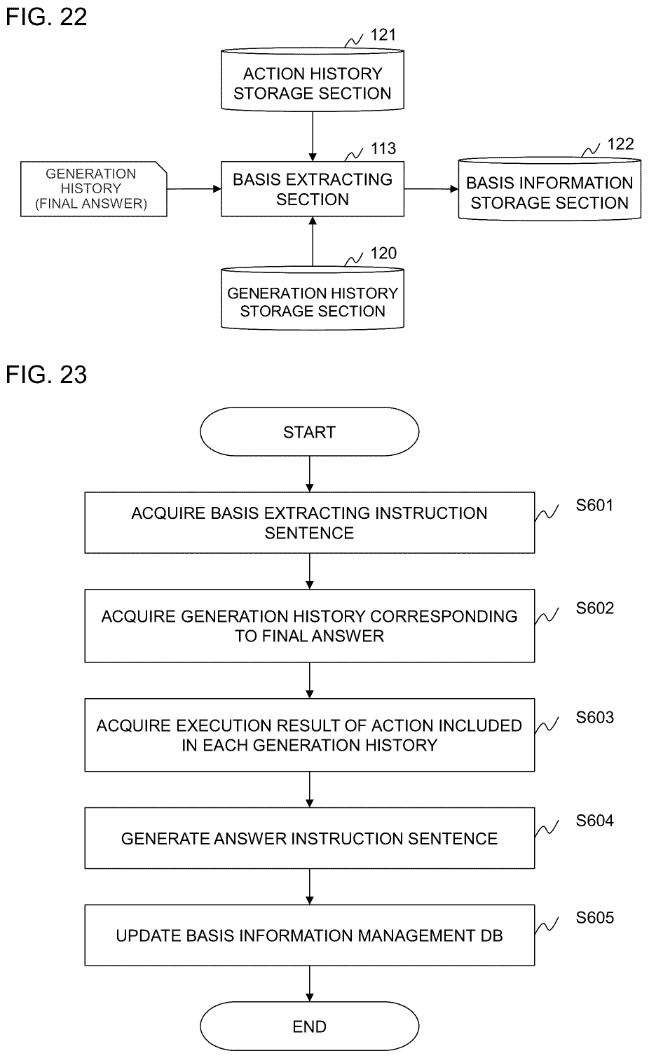

Next, a process for presenting the basis for an answer will be described. FIG. 21 is a flowchart illustrating an example of a basis information generation process executed by the basis extracting section 113 of the answer generating section 110 according to the first embodiment. FIG. 22 is a conceptual diagram of the basis information generation process executed by the basis extracting section 113 of the answer generating section 110 according to the first embodiment.

The basis extracting section 113 executes the process described below by using the completion of the answer generation process, the reception of an execution instruction from the user, and the like as execution triggers.

The basis extracting section 113 acquires the final answer (step S501).

The basis extracting section 113 divides the final answer into a plurality of sentences (step S502). The division of the final answer may be performed on a rule basis or performed by using the text generating section 140.

The basis extracting section 113 acquires, for each sentence, a result of thinking that has led to a conclusion corresponding to the relevant sentence, from the results of thinking contained in the generation history, and generates a summary of the acquired result of thinking (step S503). For example, the basis extracting section 113 acquires the result of thinking and generates a summary of the result of thinking by using the text generating section 140. The basis extracting section 113 stores the sentences and summaries in association with each other.

The basis extracting section 113 acquires, for each sentence, the execution result (observation) of an action performed to obtain the acquired result of thinking, from the generation history management DB 800 (step S504). That is, the execution result of the action performed based on the result of thinking is acquired. To be specific, the basis extracting section 113 searches a generation history in which the acquired result of thinking is stored, and acquires text stored in the observation 804 of the generation history.

The basis extracting section 113 acquires an action history corresponding to each observation from the action history management DB 900 (step S505). To be specific, the basis extracting section 113 acquires an action history from the action history management DB 900, based on the process number 801 of the generation history in which the acquired result of thinking is stored.

The basis extracting section 113 generates basis information for each sentence by using the sentence, the summary of the result of thinking, the execution result of the action, and the action history, and registers the generated basis information in the basis information management DB 1000 (step S506). After that, the basis extracting section 113 ends the basis information generation process.

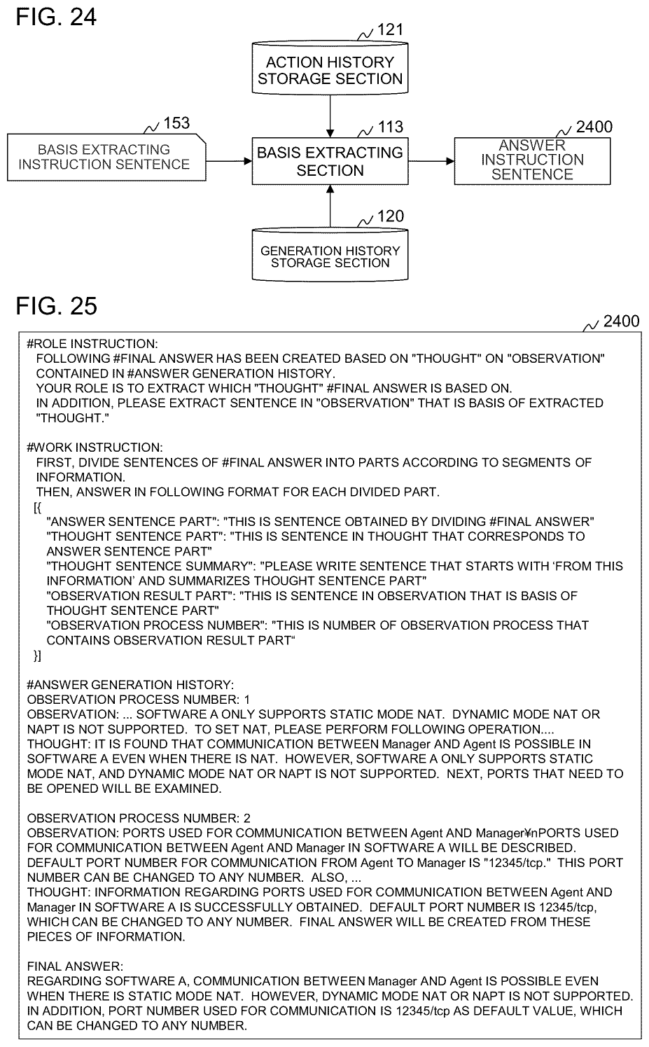

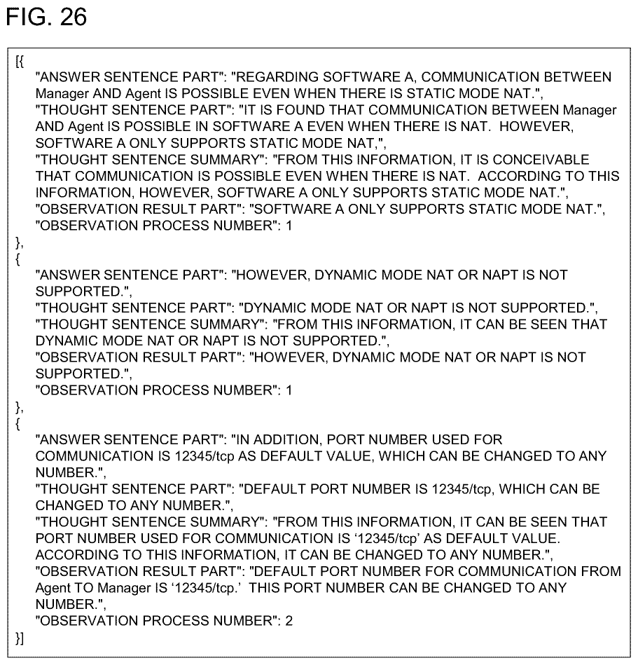

Note that the text generating section 140 may be made to generate the basis information. In this case, a process is performed as follows. FIG. 23 is a flowchart illustrating an example of a basis information generation process executed by the basis extracting section 113 of the answer generating section 110 of the first embodiment. FIG. 24 is a conceptual diagram of the basis information generation process executed by the basis extracting section 113 of the answer generating section 110 of the first embodiment. FIG. 25 is a diagram illustrating an example of the answer instruction sentence in the first embodiment. FIG. 26 is a diagram illustrating an example of the answer sentence in the first embodiment.

The basis extracting section 113 acquires the basis extracting instruction sentence 153 (step S601).

The basis extracting section 113 acquires a generation history corresponding to the final answer from the generation history management DB 800 (step S602). Specifically, the basis extracting section 113 acquires a generation history in which the observation 804 is blank.

The basis extracting section 113 acquires the execution result of an action included in each generation history, from the generation history management DB 800 (step S603).

The basis extracting section 113 generates an answer instruction sentence 2400 by inserting the generation history and the execution result of the action that correspond to the final answer into the basis extracting instruction sentence 153 (step S604), and transmits the answer instruction sentence 2400 to the text generating section 140. For example, the answer instruction sentence 2400 as illustrated in FIG. 25 is generated.

The text generating section 140 generates an answer sentence according to the answer instruction sentence 2400. For example, an answer sentence as illustrated in FIG. 26 is generated.

When receiving the answer sentence from the text generating section 140, the basis extracting section 113 updates the basis information management DB 1000, based on the answer sentence (step S605). After that, the basis extracting section 113 ends the basis information generation process.

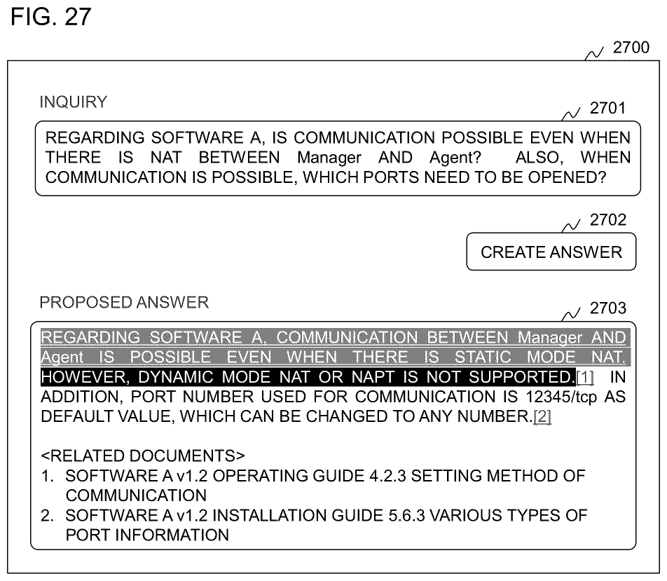

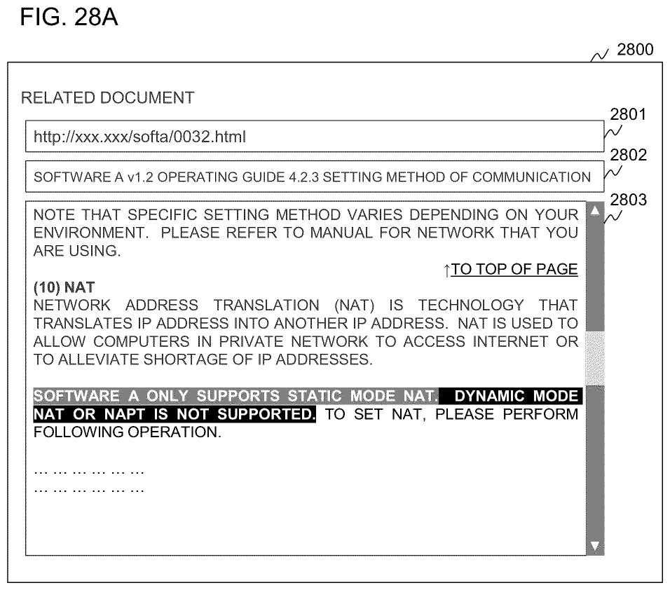

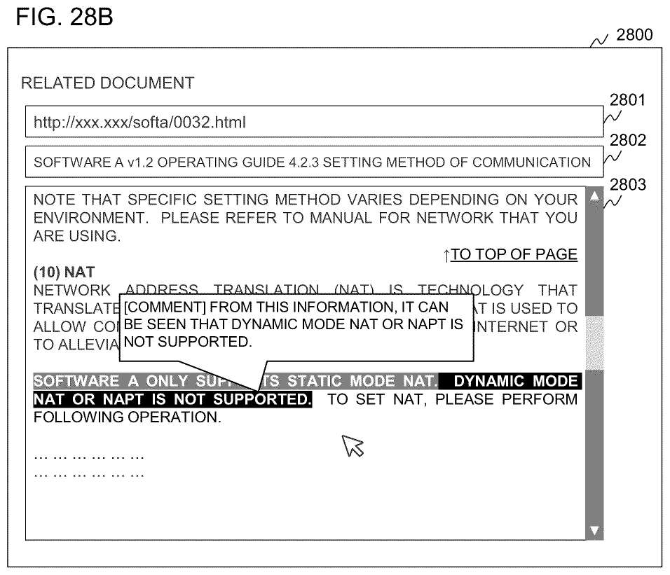

FIG. 27, FIG. 28A, and FIG. 28B are diagrams illustrating examples of screens displayed on the terminal 102 according to the first embodiment.

When receiving an access from the terminal 102, the answer generating section 110 displays a screen 2700. The screen 2700 includes an input field 2701, a button 2702, and an output field 2703.

The input field 2701 is a field for inputting the question sentence 150. The button 2702 is a button for transmitting an execution instruction including the question sentence 150, the work instruction sentence 151, and the thinking instruction sentence 152. The output field 2703 is a field for displaying the answer sentence and information related to the external information referenced as the basis for the final answer. In “related documents” in the output field 2703, part of the meta-information of the referenced external information is displayed as information related to the basis. The information can be displayed based on the basis information management DB 1000.

When the user performs an operation of clicking on a related document, for example, a screen 2800 as illustrated in FIG. 28A is displayed. The screen 2800 includes display fields 2801, 2802, and 2803.

The display field 2801 displays a storage location of the external information, and the display field 2802 displays a product name, a version, a document name, a title, etc. Further, the display field 2803 displays a basis part of the external information in a highlighted manner. When the user places a cursor on the basis part, a summary of the result of thinking is superimposed and displayed, as illustrated in FIG. 28B.

The external information to be displayed in the display field 2803 can be displayed by being acquired from the external information storage section 130. Moreover, various types of information to be displayed on the screen 2800 can be acquired from the basis information management DB 1000. The basis part can be displayed by searching for text stored in the observation 1004 of the basis information.

As described above, the answer generating section 110 can present the external information referenced as the basis for the final answer and the reference part (basis part) of the external information. This allows the user to determine whether or not the final answer is correct.

It is to be noted that the present invention is not limited to the above-mentioned embodiment and includes various modified examples. Further, for example, in the above-mentioned embodiment, the configuration is described in detail for easy understanding of the present invention, but the present invention is not necessarily limited to the one including all the described configurations. Also, part of the configuration of each embodiment can be added to or replaced with another configuration or deleted.

In addition, the above-mentioned configurations, functions, processing sections, processing means, etc., may be achieved in part or in whole by hardware by designing them as integrated circuits, for example. Further, the present invention may also be implemented by software program code that fulfills the functions of the embodiment. In this case, a storage medium in which the program code is recorded is provided to a computer, and a processor of the computer reads the program code stored in the storage medium. In this case, the program code itself read from the storage medium fulfills the above-mentioned functions of the embodiment, and the program code itself and the storage medium storing the program code constitute the present invention. Examples of the storage medium for supplying such program code include a flexible disk, a compact disc read-only memory (CD-ROM), a digital versatile disc (DVD)-ROM, a hard disk, an SSD, an optical disk, a magneto-optical disk, a CD-recordable (R) disc, a magnetic tape, a non-volatile memory card, a ROM, etc.

In addition, the program code for fulfilling the functions described in the present embodiment can be implemented in a wide range of programs or script languages, such as an assembler, C/C++, perl, Shell, PHP, Python, Java (registered trademark), etc.

Further, the program code of the software that fulfills the functions of the embodiment may be distributed over a network and stored in storage means such as a hard disk or memory of a computer or in a storage medium such as a CD-rewritable (RW) disc or a CD-R disc, and the processor of the computer may read out and execute the program code stored in the storage means or the storage medium.

In the above-mentioned embodiment, control lines and information lines which are considered necessary for the explanation are illustrated, and not all the control lines and information lines are illustrated in the product. All the components may be connected to each other.

What is claimed is:

1. A computer system comprising:
a processor;
a storage device connected to the processor; and
a network interface connected to the processor,
the computer system being connected, accessible to a large-scale language model that executes a task according to an instruction sentence describing contents of the task and a database that manages external information that is a document the large-scale language model references to execute the task, wherein
the processor executes an answer generation process of receiving a question and generating an answer to the question by using the large-scale language model and a basis extraction process of identifying a reference part of the external information that the large-scale language model has referenced to generate the answer,
the answer generation process includes
a first process of generating an answer instruction sentence and inputting the answer instruction sentence to the large-scale language model, the answer instruction sentence causing the large-scale language model to execute a task of thinking about an action to be taken to obtain the answer, the action including retrieving and collecting the external information, and generating an answer sentence including a result of the thinking and at least either the answer or information regarding the action that needs to be taken according to the thinking,
a second process of, when receiving the answer sentence including the information regarding the action, executing the action, generating a history including an execution result of the action, meta-information of the external information retrieved through the action, and the result of the thinking included in the answer sentence, generating the answer instruction sentence including the execution result, and inputting the answer instruction sentence to the large-scale language model, and
a third process of, when receiving the answer sentence including the answer, outputting the answer, and
the basis extraction process includes a fourth process of generating basis information for identifying the reference part of the external information that the large-scale language model has referenced to generate the answer, based on a plurality of the histories.

2. The computer system according to claim 1, wherein
the processor, in the fourth process,
divides the answer into a plurality of sentences,
acquires, for each of the plurality of sentences, a result of the thinking that has led to a conclusion corresponding to the relevant sentence, the execution result of the action taken to obtain the result of the thinking, and the meta-information of the external information retrieved through the action, from the plurality of the histories, and
generates the basis information in which the sentence, the result of the thinking, the execution result, and the meta-information are associated with each other.

3. The computer system according to claim 2, wherein
the processor presents a first interface for displaying the answer and the external information that the large-scale language model has referenced to generate the answer, based on the answer and the basis information.

4. The computer system according to claim 3, wherein
a sentence included in the external information is acquired in the action as the execution result,
at least part of the meta-information of the external information is displayed on the first interface, and
the processor
receives a request to reference the external information that the large-scale language model has referenced to generate the answer, via the first interface,
acquires the external information from the database, based on the meta-information of the external information to be referenced,
acquires the basis information including the meta-information of the acquired external information,
retrieves, from the acquired external information, a sentence corresponding to the execution result included in the acquired basis information, and
presents a second interface for displaying the sentence retrieved from the external information.

5. The computer system according to claim 4, wherein
the processor displays the result of the thinking contained in the acquired basis information, together with the sentence retrieved from the external information, via the second interface.

6. The computer system according to claim 1, wherein
the processor, in the fourth process,
generates a basis extracting instruction sentence including the answer and the plurality of the histories and causing the large-scale language model to execute a task of generating the basis information by using the plurality of the histories, and
acquires the basis information from the large-scale language model, and
the basis extraction instruction sentence contains instructions to divide the answer into a plurality of sentences,
acquire, for each of the plurality of sentences, a result of the thinking that has led to a conclusion corresponding to the relevant sentence, the execution result of the action taken to obtain the result of the thinking, and the meta-information, from the plurality of the histories, and
generate the basis information in which the sentence, the result of the thinking, the execution result, and the meta-information are associated with each other.

7. A method for processing information by a computer system,
the computer system
including a processor, a storage device connected to the processor, and a network interface connected to the processor, and
being connected, accessible to a large-scale language model that executes a task according to an instruction sentence describing contents of the task and a database that manages external information that is a document the large-scale language model references to execute the task,
the method comprising:
by the processor,
receiving a question and generating an answer to the question by using the large-scale language model; and
identifying a reference part of the external information that the large-scale language model has referenced to generate the answer, wherein
the generating the answer includes,
by the processor,
generating an answer instruction sentence and inputting the answer instruction sentence to the large-scale language model, the answer instruction sentence causing the large-scale language model to execute a task of thinking about an action to be taken to obtain the answer, the action including retrieving and collecting the external information, and generating an answer sentence including a result of the thinking and at least either the answer or information regarding the action that needs to be taken according to the thinking,
when receiving the answer sentence including the information regarding the action, executing the action, generating a history including an execution result of the action, meta-information of the external information retrieved through the action, and the result of the thinking included in the answer sentence, generating the answer instruction sentence including the execution result, and inputting the answer instruction sentence to the large-scale language model, and
when receiving the answer sentence including the answer, outputting the answer, and
the identifying the reference part includes, by the processor, generating basis information for identifying the reference part of the external information that the large-scale language model has referenced to generate the answer, based on a plurality of the histories.

8. The method for processing information according to claim 7, wherein
the identifying the reference part further includes,
by the processor,
dividing the answer into a plurality of sentences,
acquiring, for each of the plurality of sentences, a result of the thinking that has led to a conclusion corresponding to the relevant sentence, the execution result of the action taken to obtain the result of the thinking, and the meta-information of the external information retrieved through the action, from the plurality of the histories, and
generating the basis information in which the sentence, the result of the thinking, the execution result, and the meta-information are associated with each other.

9. The method for processing information according to claim 8, further comprising:
by the processor, presenting a first interface for displaying the answer and the external information that the large-scale language model has referenced to generate the answer, based on the answer and the basis information.

10. The method for processing information according to claim 9, wherein
a sentence included in the external information is acquired in the action as the execution result,
at least part of the meta-information of the external information is displayed on the first interface, and
the method further includes,
by the processor,
receiving a request to reference the external information that the large-scale language model has referenced to generate the answer, via the first interface,
acquiring the external information from the database, based on the meta-information of the external information to be referenced,
acquiring the basis information including the meta-information of the acquired external information,
retrieving, from the acquired external information, a sentence corresponding to the execution result included in the acquired basis information, and
presenting a second interface for displaying the sentence retrieved from the external information.

11. The method for processing information according to claim 10, further comprising:
by the processor, displaying the result of the thinking contained in the acquired basis information, together with the sentence retrieved from the external information, via the second interface.
